(19) United States
(12) Patent Application Publication
(10) Pub. No.: US 2013/0057780 A1
(43) Pub. Date: Mar. 7, 2013

(54) TELEVISION RECEIVER AND ELECTRONIC DEVICE

(71) Applicants: Yuichi HIRAI, Tokyo (JP); Atsushi TATEMICHI, Tokyo (JP)

(72) Inventors: Yuichi HIRAI, Tokyo (JP); Atsushi TATEMICHI, Tokyo (JP)

(73) Assignee: Kabushiki Kaisha Toshiba, Tokyo (JP)

(21) Appl. No.: 13/356,974

(22) Filed: Jan. 24, 2012

(30) Foreign Application Priority Data
Sep. 1, 2011 (JP) 2011-190919

(51) Int. Cl. H04N 5/64; F21V 5/00

(52) U.S. Cl. 348/836; 362/311.01; 348/E05.128

(57) ABSTRACT

In one embodiment, a television receiver includes a housing having a first surface, a second surface located on an opposite side of the first surface, and a third surface connecting the first and second surfaces. The receiver further includes a circuit board accommodated in the housing, having a first board surface facing toward the first surface side, and a second board surface facing toward the second surface side. The receiver further includes a light source disposed on the first board surface of the circuit board, and at least one lens to adjust an optical path of light emitted from the light source. The receiver further includes a first indicator provided on the first surface of the housing to transmit the light from the light source, and a second indicator provided on the third surface of the housing to transmit the light from the light source through the lens.

### CROSS REFERENCE TO RELATED APPLICATION

This application is based upon and claims the benefit of priority from the prior Japanese Patent Application No. 2011-190919, filed on Sep. 1, 2011, the entire contents of which are incorporated herein by reference.

### FIELD

Embodiments described herein relate to a television receiver and an electronic device.

### BACKGROUND

In general, a television receiver includes plural indicators. In a conventional television receiver, a light source such as an LED (Light Emitting Diode) must be prepared for each indicator.

### BRIEF DESCRIPTION OF THE DRAWINGS

FIG. 1 is a front view illustrating an appearance of a television receiver of a first embodiment;

FIG. 2 is a sectional view illustrating a structure of the television receiver of the first embodiment;

FIG. 3 is a perspective view illustrating an appearance of a notebook PC of a second embodiment;

FIGS. 4A to 4F are six hexagonal views illustrating an appearance of the notebook PC of the second embodiment;

FIG. 5 is a perspective view illustrating an inner structure of the notebook PC of the second embodiment;

FIGS. 6A and 6B are perspective views illustrating a structure of a connection unit of first and second main body units;

FIG. 7 is an enlarged perspective view of the connection unit of FIGS. 6A and 6B;

FIG. 8 is an enlarged sectional view of the connection unit of FIGS. 6A and 6B;

FIG. 9 is a front view illustrating an appearance of the second main body unit;

FIGS. 10A and 10B are front and perspective views illustrating a structure of a circuit board for click buttons;

FIG. 11 is a front view illustrating an inner structure of the second main body unit;

FIGS. 12A and 12B are front and perspective views illustrating a shape of a first lens;

FIGS. 13A and 13B are front and perspective views illustrating a shape of a second lens;

FIG. 14 is a front view for explaining a method for attaching the circuit board for the click buttons; and

FIG. 15 is a front view illustrating a specific example of first indicators.

### DETAILED DESCRIPTION

Embodiments will now be explained with reference to the accompanying drawings.

An embodiment described herein is a television receiver including a housing having a first surface, a second surface located on an opposite side of the first surface, and a third surface connecting the first surface and the second surface. The receiver further includes a circuit board accommodated in the housing, having a first board surface facing toward the first surface side, and a second board surface facing toward the second surface side. The receiver further includes a light source disposed on the first board surface of the circuit board, and at least one lens to adjust an optical path of light emitted from the light source. The receiver further includes a first indicator provided on the first surface of the housing to transmit the light emitted from the light source, and a second indicator provided on the third surface of the housing to transmit the light which is emitted from the light source and transmitted through the lens.

Another embodiment described herein is an electronic device including a housing, a light source accommodated in the housing, and at least one lens to adjust an optical path of light emitted from the light source. The device further includes a first indicator provided in the housing to transmit the light emitted from the light source, and a second indicator provided in the housing to transmit the light which is emitted from the light source and transmitted through the lens.

### First Embodiment

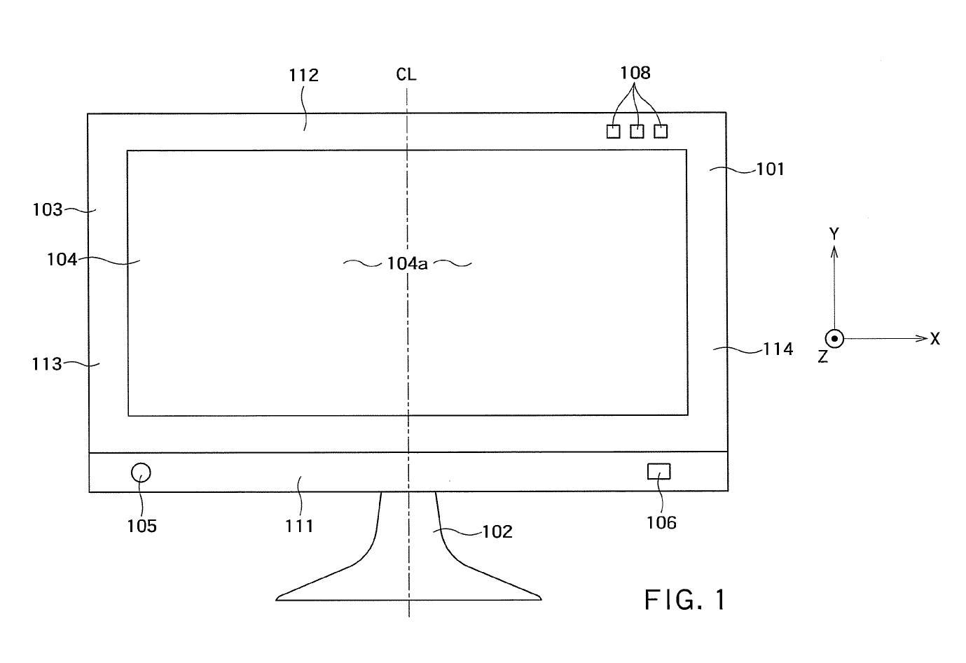

FIG. 1 is a front view illustrating an appearance of a television receiver of a first embodiment.

The television receiver of FIG. 1 includes a main body unit (display unit) 101 and a leg unit (a stand, a supporting unit, a bearing unit, and a mounting unit) 102. In the embodiment, a top and a bottom are defined based on an attitude in which the leg unit 102 supports the main body unit 101. The right and the left are defined based on a point of sight of a user, and a position closer to the user is designed as a front position while a position farther away from the user is defined as a back position. In FIG. 1, a direction from the left toward the right, a direction from the bottom toward the top, and a direction from the back position toward the front position are indicated by an X-direction, a Y-direction, and a Z-direction, respectively.

The main body unit 101 includes a housing (a cover member, a combined member, a member, and a component) 103, a display device (a display module, a display unit, and an electronic component) 104 that is accommodated in the housing 103, a power button 105 that is provided on a front surface (a front face, on a display screen side) of the housing 103, a remote controller sensor 106, and a first indicator 108. The display device 104 includes a display screen 104a that is exposed to the front surface of the housing 103. An ON/OFF operation of the display screen 104a can be performed by pressing the power button 105, or by pressing a power button of a remote controller while a front portion of the remote controller faces toward a direction of the remote controller sensor 106.

The housing 103 includes first to fourth end portions (a side, a periphery, an edge portion, a side portion, a wall, and a surface) 111 to 114. The first end portion 111 is an end portion (a bottom surface, a bottom wall, a supporting surface, a supporting unit, and a peripheral wall) to which the leg unit 102 is attached. The second end portion (a top panel, an upper wall, a wall, a surface, and a peripheral wall) 112 is located on the opposite side of the first end portion 111, and extends in substantially parallel to the first end portion 111. The third end portion (a side portion, a side surface, a sidewall, and a peripheral wall) 113 connects the first end portion 111 and the second end portion 112, and extends in a direction substantially perpendicular to the first end portion 111. The fourth end portion (a side portion, a side surface, a sidewall, and a peripheral wall) 114 is located on the opposite side of the third end portion 113, and extends in substantially parallel to the third end portion 113. Similarly to the third end portion 113, the fourth end portion 114 connects the first end portion 111 and the second end portion 112.

The first and second end portions 111 and 112 extend in a lengthwise direction of the housing 103. On the other hand, the third and fourth end portions 113 and 114 extend in a crosswise direction of the housing 103, and are shorter than the first and second end portions 111 and 112.

If the leg unit 102 supports the main body unit 101, the first to fourth end portions 111 to 114 constitute a lower end portion, an upper end portion, a left end portion, and a right end portion of the housing 103, respectively. In FIG. 1, the first and second end portions 111 and 112 are substantially parallel to the X-direction, and the third and fourth end portions 113 and 114 are substantially parallel to the Y-direction. A straight line CL of FIG. 1 indicates a center line of the first end portion 111 and the second end portion 112.

In the embodiment, the housing 103 includes the four end portions 111 to 114. Alternatively, the housing 103 may include three end portions or less or at least five end portions. The first end portion 111 and the second end portion 112 may extend while being not parallel to each other. Similarly the third end portion 113 and the fourth end portion 114 may extend while being not parallel to each other.

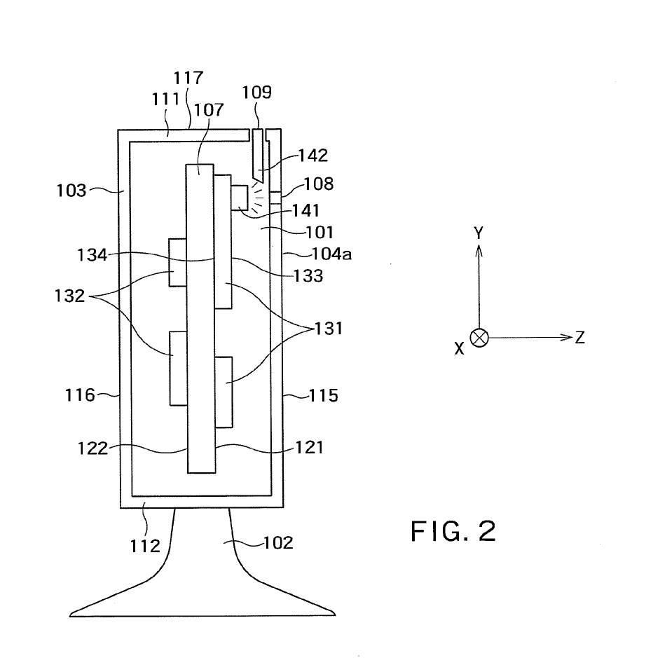

FIG. 2 is a sectional view illustrating a structure of the television receiver of the first embodiment.

As illustrated in FIG. 2, the housing 103 includes a front surface (a first surface, a first wall, a wall, and a mask) 115, a back surface (a second surface, a second wall, a wall, and a cover) 116, and a peripheral surface (a third surface, a third wall, a wall, part of the mask or part of the cover, and a portion covering the mask and the cover) 117. The front surface 115 is a surface to which the display screen 104a is exposed. The back surface 116 is located on the opposite side of the front surface 115. The peripheral surface 117 connects the edge portion of the front surface 115 and the edge portion of the back surface 116.

In the embodiment, the housing 103 has a planar structure including the front surface 115, the back surface 116, and the peripheral surface 117. Alternatively, the housing 103 may have a planar structure except that of the embodiment.

As illustrated in FIG. 2, the main body unit 101 also includes a middle frame (a housing, a supporting unit, a supporting surface, a supporting wall, a component placing unit, a frame, an intermediate member, a bone member, a plate, and a reinforcement unit) 107 that is accommodated in the housing 103. The middle frame 107 is a supporting member that supports various components.

The middle frame 107 includes a first supporting surface (first surface) 121 and a second supporting surface (second surface) 122. The first supporting surface 121 faces toward the side of the front surface 115. The second supporting surface 122 faces toward the side of the back surface 116, and located on the opposite side of the first supporting surface 121.

The main body unit 101 includes a first electronic component 131 that is disposed on the first supporting surface 121 of the middle frame 107 and a second electronic component 132 that is disposed on the second supporting surface 122 of the middle frame 107. A circuit board on which a semiconductor element and a circuit element are mounted can be cited as an example of the electronic components 131 and 132. A component except the electronic components 131 and 132 may be disposed on the surface, domain, portion, and supporting unit of the middle frame 107, such as the supporting surfaces 121 and 122 of the middle frame 107.

In FIG. 2, the first electronic component 131 that is of a circuit board includes a first board surface (first surface) 133 and a second board surface (second surface) 134. The first board surface 133 faces toward the side of the front surface 115. The second board surface 134 faces toward the side of the back surface 116, and located on the opposite side of the first board surface 133. The second board surface 134 is placed in the first supporting surface 121.

The main body unit 101 also includes an LED 141 that is disposed on the first board surface 133 and at least one lens 142 that adjusts an optical path of light emitted from the LED 141. The LED 141 is disposed such that a light emitting surface of the LED 141 faces toward the front surface 115. The LED 141 is an example of the light source.

The lens 142 of FIG. 2 may be replaced by a light guiding unit that guides the light, a translucent unit that transmits the light, or a transparent unit that is made of a transparent material. The light guiding unit, the translucent unit, or a transparent unit may be a lens different from the lens 142 of FIG. 2 or a component except the lens.

The main body unit 101 further includes a first indicator 108 that transmits the light emitted from the LED 141 and a second indicator 109 that transmits the light, which is emitted from the LED 141 and transmitted through the lens 142. The first indicator 108 is provided on the front surface 115 of the housing 103, and the second indicator 109 is provided on the peripheral surface 117 of the housing 103.

The indicators 108 and 109 are display units that display the state of the television receiver. For example, the indicators 108 and 109 are used to display whether the power of the television receiver is turned on or off. Physically, the indicators 108 and 109 correspond to the translucent unit that transmits the light or the transparent unit that is made of the transparent member. In the embodiment, the first indicator 108 is made of the transparent member, and the second indicator 109 is the light emitting surface of the lens 142 as illustrated in FIG. 2.

As illustrated in FIG. 2, the first indicator 108 is disposed in front of the light emitting surface of the LED 141. Therefore, the light emitted from the LED 141 can be incident to the first indicator 108 without passing through the lens 142. In the embodiment, the lens 142 is not disposed between the light emitting surface of the LED 141 and the first indicator 108, and the light emitted from the LED 141 is directly incident to the first indicator 108 without passing through the lens 142. Therefore, according to the embodiment, the light having a strong light intensity can be incident to the first indicator 108.

On the other hand, as illustrated in FIG. 2, because the second indicator 109 is disposed lateral to the light emitting surface of the LED 141, the light emitted from the LED 141 is hardly incident to the second indicator 109 unless the optical path of the light is adjusted. In the embodiment, the lens 142 is disposed on the optical path of the light emitted from the LED 141, thereby causing the light to be incident to the second indicator 109. Therefore, according to the embodiment, not only the first indicator 108 but also the second indicator 109 can be brightened.

As described above, in the embodiment, the light emitted from the LED 141 is incident to both the first indicator 108 and the second indicator 109 by dividing the optical path of the light emitted from the LED 141 into two directions. Therefore, according to the embodiment, the first and second indicators 108 and 109 can be brightened by the same light emitted from the LED 141.

As illustrated in FIG. 1, the television receiver of the embodiment includes three first indicators 108. The television receiver of the embodiment also includes the three second indicators 109. According to the embodiment, the indicators 108 and 109 can be brightened by not six but three LEDs 141. In the embodiment, the number of LEDs 141 for indicators 108 and 109 can be decreased.

The number of first and second indicators 108 and 109 of the television receiver may be two or one or at least four. The television receiver may have a structure in which at least three indicators is brightened by one LED 141. The television receiver may include both the LED 141 that makes at least two indicators brighten and the LED 141 that makes only one indicator brighten.

The first embodiment can also be applied to an electronic device, except the television receiver, for example, a notebook PC (Personal Computer). An example of the notebook PC will be described in a second embodiment.

### Second Embodiment

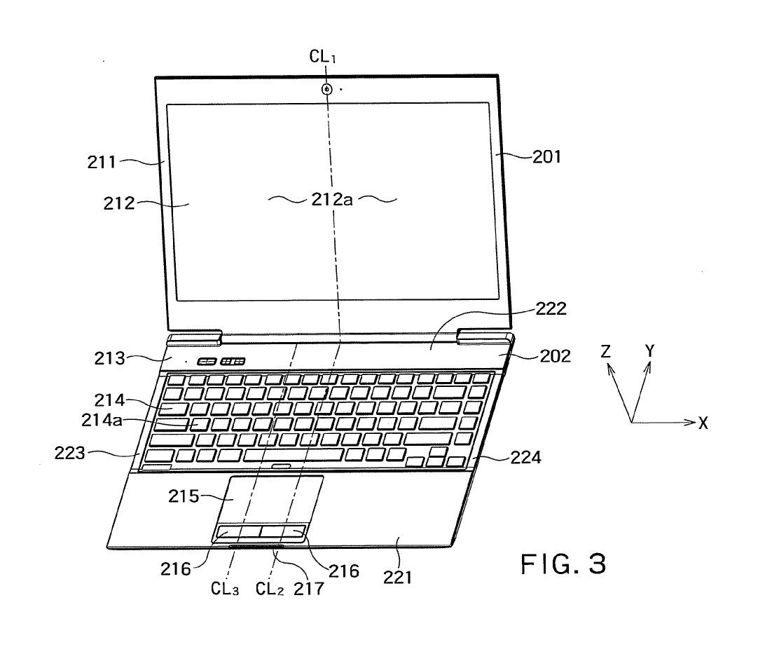

FIG. 3 is a perspective view illustrating an appearance of a notebook PC of the second embodiment. The notebook PC of FIG. 3 may be a PC that acts as the television receiver or a PC that does not act as the television receiver.

The PC of FIG. 3 includes a first main body unit (a first portion and a first component accommodation unit) 201 and a second main body unit (a second portion and a second component accommodation unit) 202.

The first main body unit 201 includes a first housing (a cover member, a member, an assembly component, a component, a supporting unit, and a reinforcement unit) 211 and a display device (a display module, a display unit, an electronic component, and a component) 212 that is accommodated in the first housing 211. The display device 212 includes a display screen 212a that is exposed to a front surface of the first housing 211. A straight line CL₁ of FIG. 3 indicates a center line of the first housing 211.

The second main body unit 202 includes a second housing (a cover member, a member, an assembly component, a component, a supporting unit, and a reinforcement unit) 213, a keyboard (an input unit, an input receiving unit, a receiving unit, an operation unit, an operation domain, an interface unit, an input module, a unit, and a component) 214 that is accommodated in the second housing 213, a pointing device (an input unit, an input receiving unit, a receiving unit, an operation unit, an operation domain, an interface unit, an input module, a unit, a component, a surface, and a domain in which a touch sensor functions) 215 that is provided on the front surface of the second housing 213, clickpads (input units, input receiving units, receiving units, operation units, operation domains, interface units, input modules, units, components, surfaces, and domains in which touch sensors function) 216, and a finger putting-on unit (an opening, a step unit, a recess, a hanging unit, and a projection) 217. The keyboard 214 includes plural keys 214a that are exposed to the front surface of the second housing 213. A straight line CL₂ of FIG. 3 indicates a center line of the second housing 213. A straight line CL₃ indicates a boundary line between a home position of a right hand of the keyboard 214 and a home position of a left hand of the keyboard 214.

In the second embodiment, the right and left, the top and the bottom, and the front position and back position of the second main body unit 202 are defined based on a state in which the first main body unit 201 is opened from the side closer to the user toward the side farther away from the user while the second main body unit 202 is placed on a horizontal surface. In the second embodiment, a direction parallel to the straight line connecting a left eye and a right eye of the user in the direction parallel to the horizontal surface is defined as the “right and left”, and a direction perpendicular to the straight line is defines as the “top and bottom”. A direction perpendicular to the horizontal surface is defines as the “front position and back position”, and the position closer to the user is defined as the front position while the position farther away from the user is defined as the back position. In FIG. 1, the direction from the left toward the right, the direction from the bottom toward the top, and the direction from the back position toward the front position are indicated by the X-direction, the Y-direction, and the Z-direction, respectively.

The second housing 213 includes first to fourth end portions (a side, a periphery, an edge portion, a side portion, a wall, and a surface) 221 to 224. The finger putting-on unit 217 is provided in the first end portion (an end portion on the opposite side of a hinge, an end portion in the lengthwise direction, a side, a periphery, an edge portion, a side portion, a wall, and a surface) 221. The second end portion (an end portion on the hinge side, a side, a periphery, an edge portion, a side portion, a wall, and a surface) 222 is an end portion in which a connection unit of the first housing 211 and the second housing 213 is provided. The second end portion 222 is located on the opposite side of the first end portion 221 and extends substantially-parallel/parallel to the first end portion 221. The third end portion (an end portion in the crosswise direction, a side, a periphery, an edge portion, a side portion, a wall, and a surface) 223 connects the first end portion 221 and the second end portion 222, and extends in the direction substantially perpendicular to the first end portion 221. The fourth end portion (an end portion in the crosswise direction, a side, a periphery, an edge portion, a side portion, a wall, and a surface) 224 is located on the opposite side of the third end portion 223, and extends in the direction substantially parallel to the third end portion 223. Similarly to the third end portion 223, the fourth end portion 224 connects the first end portion 221 and the second end portion 222.

The first and second end portions 221 and 222 extend in the lengthwise direction of the second housing 213. On the other hand, the third and fourth end portions 223 and 224 extends in the crosswise direction of the second housing 213, and are shorter than the first and second end portions 221 and 222.

If the first main body unit 201 is opened from the side closer to the user toward the side farther away from the user while the second main body unit 202 is placed on the horizontal surface, the first to fourth end portions 221 to 224 constitute the lower end portion, the upper end portion, the left end portion, and the right end portion of the second housing 213, respectively. In FIG. 3, the first and second end portions 221 and 222 are substantially parallel to the X-direction, and the third and fourth end portions 223 and 224 are substantially parallel to the Y-direction. The straight line CL₂ of FIG. 3 indicates the center line of the first end portion 221 and the second end portion 222.

In the second embodiment, the second housing 213 includes the four end portions 221 to 224. Alternatively, the second housing 213 may include the three end portions or less or at least the five end portions. The first end portion 221 and the second end portion 222 may extend while being not parallel to each other. Similarly the third end portion 223 and the fourth end portion 224 may extend while being not parallel to each other.

In the second embodiment, the boundary line CL₃ of the home position is located closer to the side of the third end portion 223 than the center line CL₂. Therefore, the pointing device 215 is disposed such that a gravity center of the pointing device 215 is located closer to the side of the third end portion 223 than the center line CL₂. The boundary line of the right and left clickpads 216 is located closer to the side of the third end portion 223 than the center line CL₂. The finger putting-on unit 217 is placed such that a center point of the right end and the left end of the finger putting-on unit 217 is located closer to the side of the third end portion 223 than the center line CL₂. The finger putting-on unit 217 is a recess on which the user puts the user's finger when the user uses the keyboard 214.

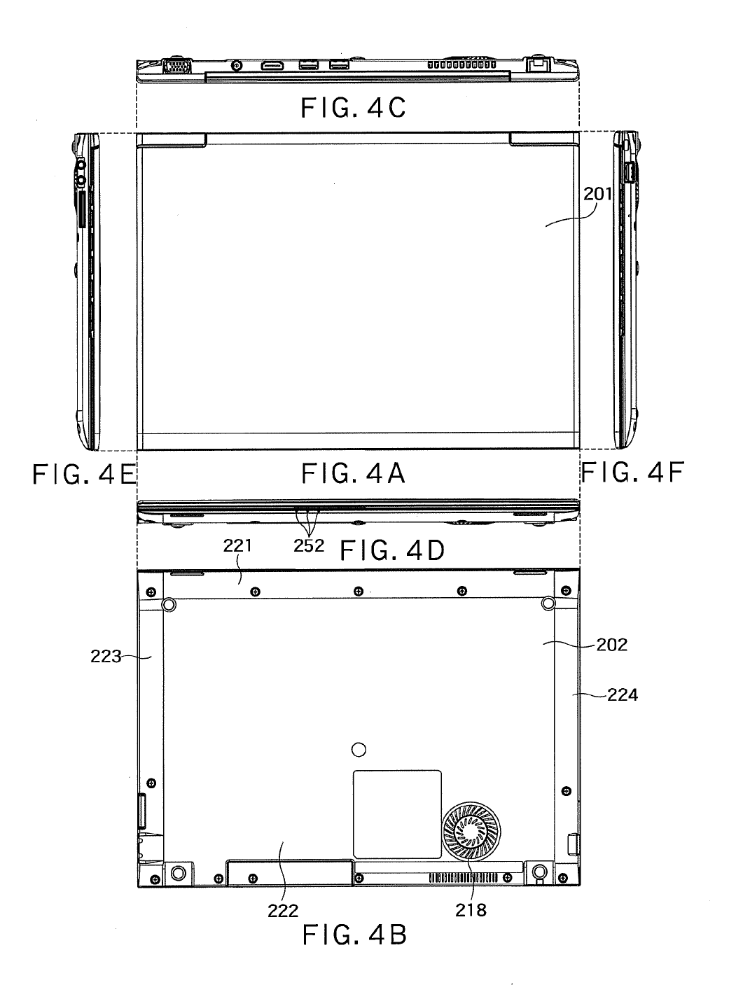

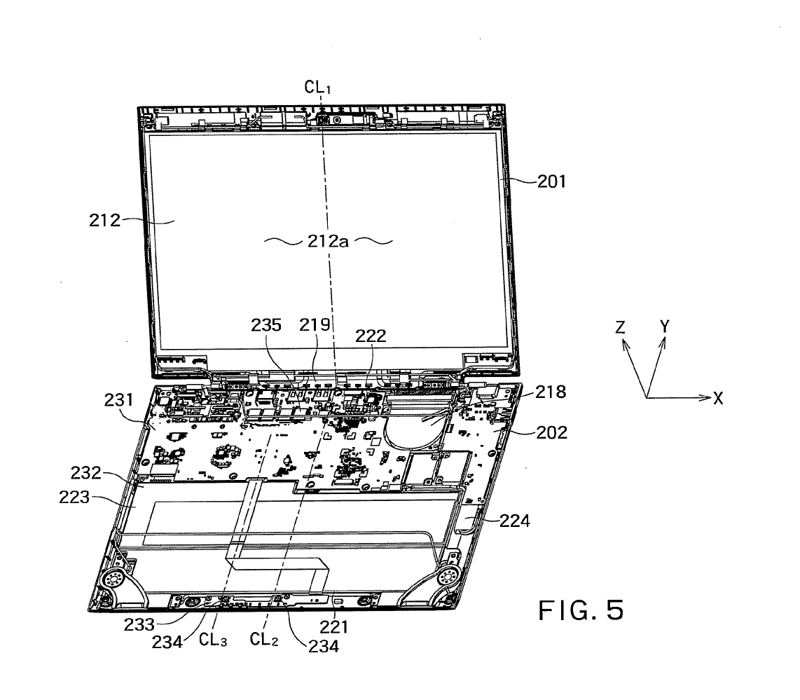

FIGS. 4A to 4F is six hexagonal views illustrating an appearance of the notebook PC of the second embodiment.

FIG. 4A is a front view of the PC of the second embodiment. FIG. 4A illustrates the back surface of the first main body unit 201. FIG. 4B is a rear view of the PC of the second embodiment. FIG. 4B illustrates the back surface of the second main body unit 202. FIGS. 4C, 4D, 4E, and 4F are a top plan view, a bottom view, a left side view, a right side view of the PC of the second embodiment, respectively.

As illustrated in FIG. 4B, a fan 218 is accommodated in the second housing 213. The fan 218 is disposed in the second end portion 222, and a vent hole of the fan 218 is provided on the back surface of the second housing 213.

FIG. 5 is a perspective view illustrating an inner structure of the notebook PC of the second embodiment.

As illustrated in FIG. 5, a main circuit board (a printed circuit board, a circuit board, a board, an electronic component, a component, and a module) 231, a battery (a battery, a power supply unit, a unit, a charging unit, a component, and a module) 232, and a circuit board 233 for click buttons 234 are accommodated in the second housing 213.

A semiconductor element such as a CPU (Central Processing Unit) 235 and a circuit element are mounted on the main circuit board 231. The main circuit board 231 is disposed in the second end portion 222. Because the fan 218 is used to cool the semiconductor element such as the CPU 235 and the circuit element, the fan 218 and the main circuit board 231 are disposed in the second end portion 222.

The battery 232 is disposed in the first end portion 221 while the circuit board 233 for the click buttons 234 is interposed therebetween. In the second embodiment, because the main circuit board 231 is disposed in a space on the side of the second end portion 222, the battery 232 is disposed in a remaining space on the side of the first end portion 221.

The click buttons 234 are mounted on the circuit board 233. The circuit board 233 is disposed in the first end portion 221. Specifically, the circuit board 233 is disposed in a position in which the clickpads 216 and the click buttons 234 overlap each other when viewed from the Z-direction.

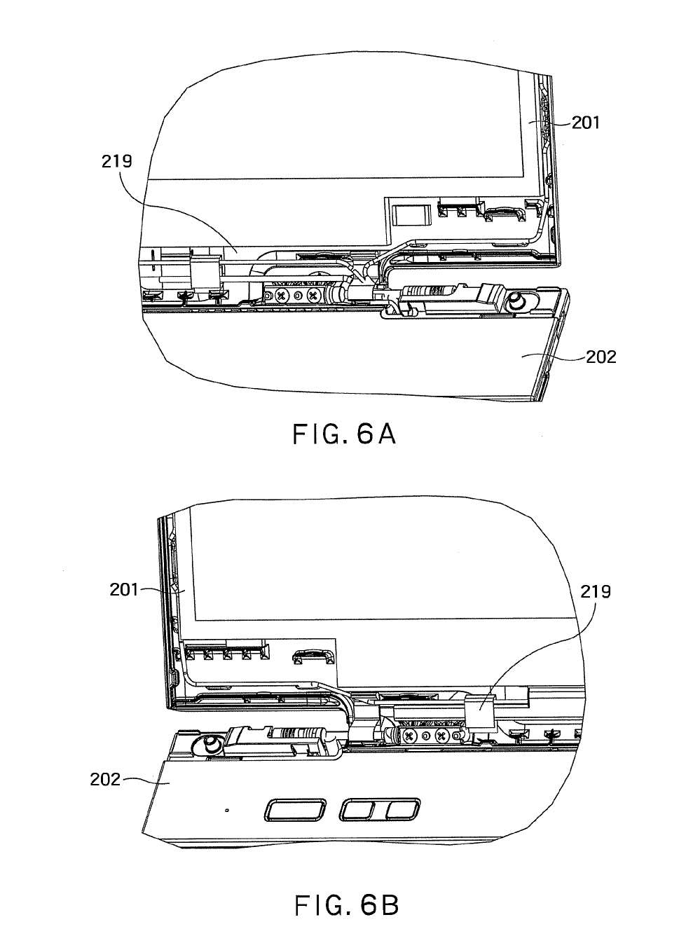

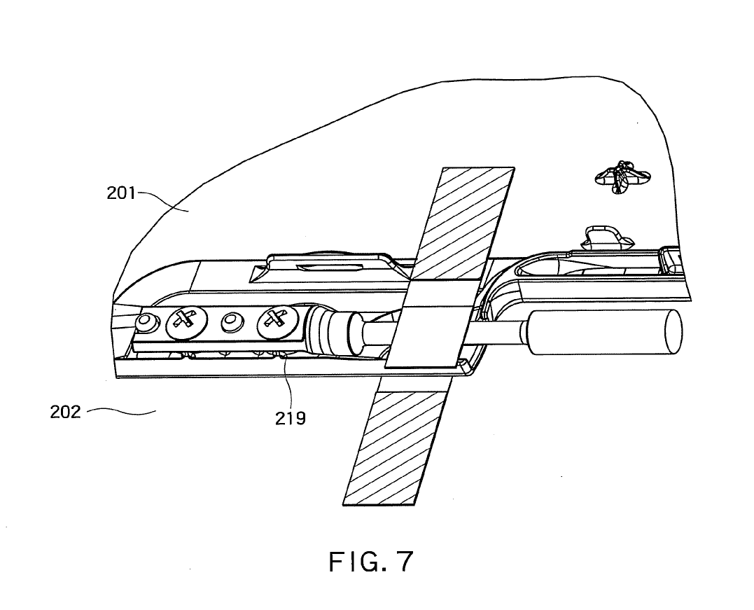

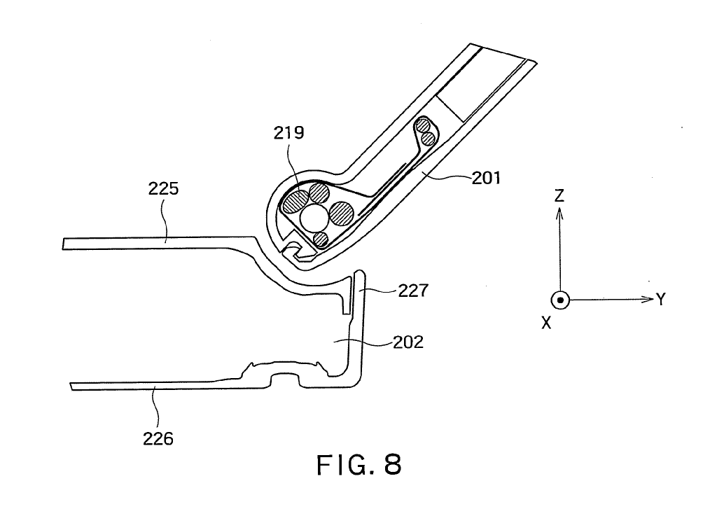

A connection unit 219 connects the first main body unit 201 and the second main body unit 202. FIGS. 6 to 8 illustrate the connection unit 219 in detail. FIGS. 6A and 6B are perspective views illustrating a structure of the connection unit (a hinge unit, hinge mechanism, a coupling unit) 219. FIG. 6A illustrates a portion on the side of the fourth end portion 224 of the connection unit 219, and FIG. 6B illustrates a portion on the side of the third end portion 223 of the connection unit 219. FIGS. 7 and 8 are an enlarged perspective view and an enlarged sectional view of the connection unit 219 of FIGS. 6A and 6B, respectively. In the second embodiment, the connection unit 219 connects the first main body unit (first housing unit) 201 and the second main body unit (second housing unit) 202.

As illustrated in FIG. 8, the second housing 213 includes a front surface (a first surface, a wall, an upper surface, an upper wall, a first casing, and a first component) 225, a back surface (a second surface, a wall, a lower surface, a bottom wall, a second casing, and a second component) 226, and a peripheral surface (a third surface, a peripheral wall, a sidewall, a wall, a surface, a domain, a side portion, and a vertical wall) 227. The keyboard 214 is exposed to the front surface 225. The back surface 226 is located on the opposite side of the front surface 225. The peripheral surface 227 connects the edge portion of the front surface 225 and the edge portion of the back surface 226. As illustrated in FIG. 8, the front surface 225 includes a dent portion in which the connection unit 219 intrudes.

The second housing 213 of the second embodiment has a planar structure including the front surface 225, the back surface 226, and the peripheral surface 227. Alternatively, the second housing 213 may have a planar structure except that of the embodiment.

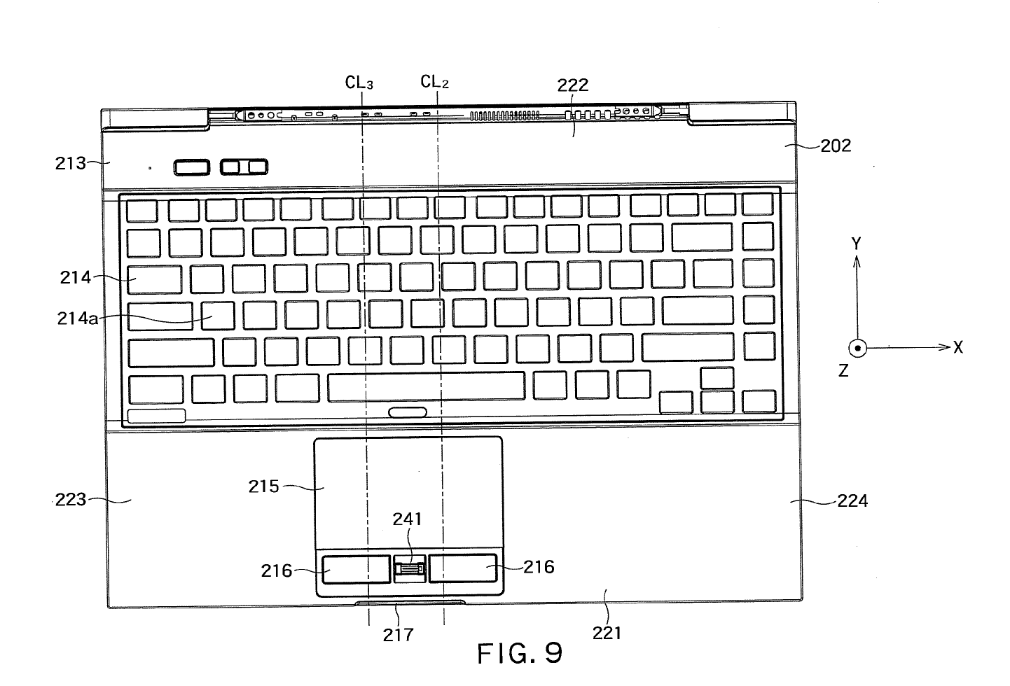

FIG. 9 is a front view illustrating an appearance of the second main body unit 202.

FIG. 9 illustrates a fingerprint authentication device 241 that is omitted in FIG. 3 for the sake of convenience. The fingerprint authentication device 241 is disposed in the front surface of the second housing 213, more particularly between the mouse pads 216 in the first end portion 221.

As described above, in the second embodiment, the boundary line CL₃ of the home position is located closer to the side of the third end portion 223 than the center line CL₂. Therefore, the fingerprint authentication device 241 is disposed such that the gravity center of the fingerprint authentication device 241 is located closer to the side of the third end portion 223 than the center line CL₂.

(1) Details of Circuit Board 233

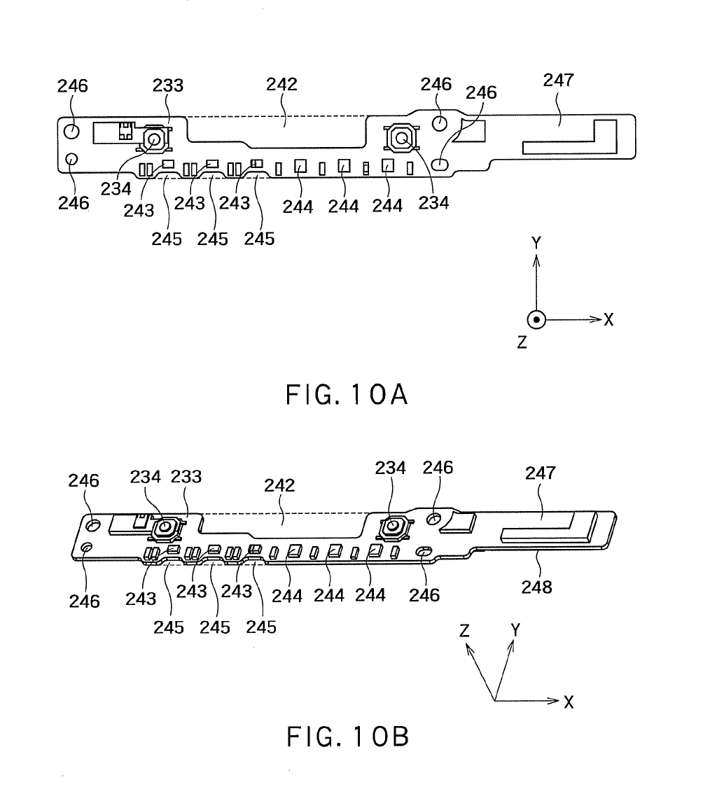

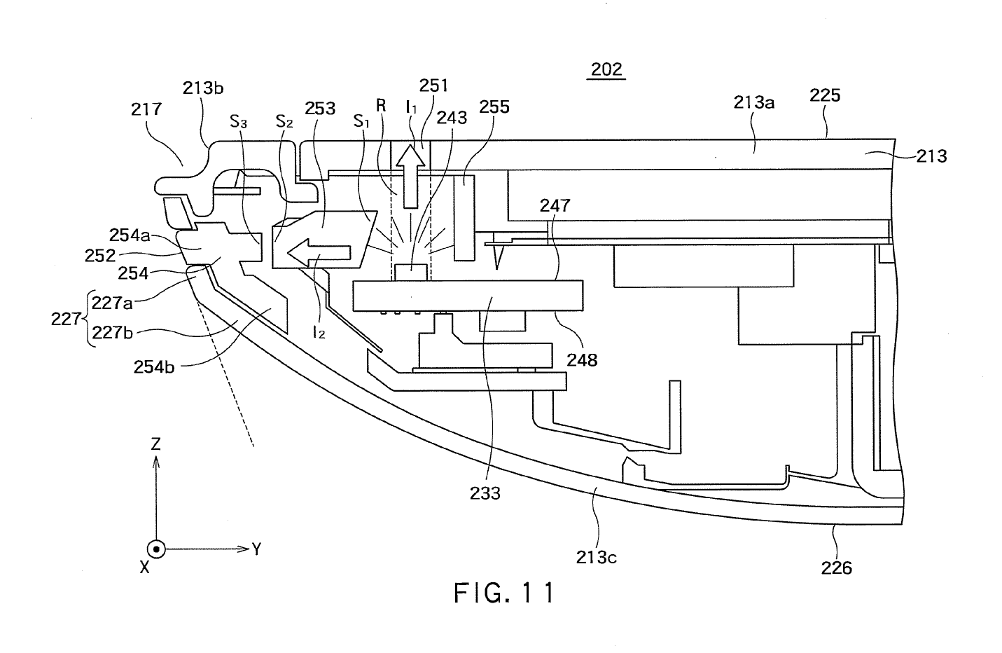

The circuit board 233 (FIG. 5) for the click buttons 234 will be described in detail with reference to FIGS. 10 and 11.

FIGS. 10A and 10B are front and perspective views illustrating a structure of the circuit board 233 for the click buttons 234.

The circuit board 233 includes a first board surface (a first surface, a domain, and a portion) 247 and a second board surface (a second surface, a domain, and a portion) 248. The first board surface 247 faces toward the side of the front surface 225 of the second housing 213. The second board surface 248 faces toward the side of the back surface 226 of the second housing 213, and located on the opposite side of the first board surface 247. The click buttons 234 are disposed on the first board surface 247 of the circuit board 233. The click buttons 234 are an example of an input operating button.

As illustrated in FIGS. 10A and 10B, the circuit board 233 includes first and second LEDs 243 and 244 that are disposed in line in the first board surface 247, first and second recesses 242 and 245 that are provided in end portions circuit board 233, and plural screw holes 246 that are pierced from the first board surface 247 to the second board surface 248.

As described later, in the second embodiment, a first indicator 251 is disposed near the first end portion 221 in the front surface 225 of the second housing 213, and a second indicator 252 is disposed near the first end portion 221 in the peripheral surface 227 of the second housing 213 (see FIG. 11).

Therefore, on the first board surface 247, the first and second LEDs 243 and 244 are disposed on the side of the first end portion 221 of the second housing 213. The first LED 243 is used to make the first and second indicators 251 and 252 brighten, and the second LED 244 is used to make only the first indicator 251 brighten. The first and second LEDs 243 and 244 are disposed such that the light emitting surfaces of the first and second LEDs 243 and 244 face toward the front surface 225.

The first recess 242 is used to accommodate the fingerprint authentication device 241 (FIG. 9). In the second embodiment, because the first and second LEDs 243 and 244 are disposed on the side of the first end portion 221 of the second housing 213, the first recess 242 is provided on the side of the second end portion 222. Thanks to the first recess 242, the fingerprint authentication device 241 can be disposed near the click buttons 234 or the first and second LEDs 243 and 244.

The second recess 245 is used to accommodate a first lens 253 (see FIG. 11) to be described later. Therefore, the second recess 245 is provided near the first LED 243 on the side of the first end portion 221. Thanks to the second recess 245, the first lens 253 can be disposed near the first LED 243.

FIG. 11 is a sectional view illustrating an inner structure of the second main body unit 202. Similarly to FIGS. 10A to 11 illustrates the first LED 243 that is disposed on the first board surface 247 of the circuit board 233.

As illustrated in FIG. 11, the second housing 213 includes an upper member 213a that constitutes almost all the front surface 225, a cover member 213b that constitutes a portion near the second end portion 222 of the front surface 225, and a lower member 213c that constitutes the back surface 226 and the peripheral surface 227. The cover member 213b includes the finger putting-on unit 217. The peripheral surface 227 includes a planar portion 227a that is located on the side of the front surface 225 and a curved portion 227b that is located on the side of the back surface 226. As illustrated in FIG. 11, the curved portion 227b extends from the peripheral surface 227 to the back surface 226.

The second main body unit 202 includes the first and second lenses 253 and 254 that adjust the optical path of the light emitted from the first LED 243. The second main body unit 202 also includes the first indicator 251 that transmits the light emitted from the first LED 243 and the second indicator 252 that transmits the light, which is emitted from the first LED 243 and transmitted through the first and second lenses 253 and 254. The first indicator 251 is provided on the front surface 225 of the second housing 213, and the second indicator 252 is provided on the peripheral surface 227 of the second housing 213.

Because the first indicator 251 is disposed in front of the light emitting surface of the first LED 243, the light emitted from the first LED 243 can be incident to the first indicator 251 without passing through the lenses 253 and 254. Therefore, in the second embodiment, the lenses 253 and 254 are not disposed between the light emitting surface of the first LED 243 and the first indicator 251, but the light emitted from the first LED 243 is directly incident to the first indicator 251 without passing through the lenses 253 and 254 as illustrated by an arrow I₁. According to the second embodiment, the light having the strong light intensity can be incident to the first indicator 251. In the second embodiment, the first indicator 251 is made of the transparent member.

On the other hand, because the second indicator 252 is disposed lateral to the light emitting surface of the first LED 243, the light emitted from the first LED 243 is hardly incident to the second indicator 252 unless the optical path of the light is adjusted. In the second embodiment, the lenses 253 and 254 are disposed on the optical path of the light emitted from the first LED 243, thereby causing the light to be incident to the second indicator 252 as illustrated by an arrow I₂. Therefore, according to the second embodiment, not only the first indicator 251 but also the second indicator 252 can be brightened.

The second main body unit 202 also includes a light-shielding member 255 that is disposed lateral to the first and second LEDs 243 and 244. The light-shielding member 255 has an effect to prevent the pieces of light, which is emitted from the first and second LEDs 243 and 244, from diffusing in the second housing 213.

The first and second lenses 253 and 254 will be described in detail with reference to FIG. 11.

As illustrated in FIG. 11, the second main body unit 202 includes the first lens 253 that transmits the light emitted from the first LED 243 and the second lens 254 that transmits the light transmitted through the first lens 253. The advantage that the second main body unit 202 is easily assembled is obtained by dividing the lens for first LED 243 into the two lenses 253 and 254. The first lens 253 is attached to the upper member 213a, and the second lens 254 is attached to the lower member 213c.

The first lens 253 includes a light receiving surface S₁ and a light emitting surface S₂. The light receiving surface S₁ is tilted with respect to the direction perpendicular to the first board surface 247, namely, the Z-direction. The tilt exerts an effect to easily receive the light emitted from the first LED 243 and an effect to bend the optical path of the light. For example, an angle of the light receiving surface S₁ to the Z-direction ranges, for example, from 5 degrees to 15 degrees, more particularly about 10 degrees.

The second lens 254 includes a light receiving surface S₃ and a light emitting surface that acts as the second indicator 252. The use of the light emitting surface of the second lens 254 as the second indicator 252 has the advantage to eliminate the need to prepare the transparent member for second indicator 252 independently of the second lens 254. Additionally, there is the advantage to be able to avoid a decrease in light quantity due to the transparent member.

In the second embodiment, the light receiving surface S₃ of the second lens 254 is provided in parallel to the light emitting surface S₂ of the first lens 253. Therefore, advantageously the second lens 254 easily receives the light from the first lens 253.

In the second embodiment, as illustrated in FIG. 11, an area of the light receiving surface S₃ of the second lens 254 is smaller than an area of the light emitting surface S₂ of the first lens 253. Therefore, advantageously the diffusion of the light is suppressed in the second lens 254 and unevenness of the light is hardly generated in the second lens 254.

In the second embodiment, the second indicator 252 is provided in the planar portion 227a of the peripheral surface 227. In the disposition of the second embodiment, for example, the light emitting surface of the second lens 254 is flattened to decrease a step between the peripheral surface 227 and the second indicator 252, which advantageously allows the design of the apparatus to be enhanced.

A domain R of FIG. 11 indicates a domain in which the first LED 243 and the first indicator 251 overlap each other in the Z-direction. In the second embodiment, the lenses 253 and 254 are located outside the domain R, but not invade in the domain R. Therefore, as indicated by an arrow I₁, the light emitted from the first LED 243 is directly incident to the first indicator 251 without passing through the lenses 253 and 254.

As described above, in the second embodiment, the light emitted from the same first LED 243 can be incident to both the first indicator 251 and the second indicator 252 by dividing the optical path of the light emitted from the first indicator 251 into the two directions. Therefore, according to the second embodiment, the first and second indicators 251 and 252 can be brightened by the light emitted from the same first LED 243.

As illustrated in FIG. 4D, the notebook PC of the second embodiment includes the three second indicators 252. The notebook PC of the second embodiment also includes the three first indicators 251 as the first indicator 251 for first LED 243. In the second embodiment, the indicators 251 and 252 can be brightened by not six but three first LEDs 243. According to the second embodiment, the number of first LEDs 243 for indicators 251 and 252 can be decreased.

The first and second indicators 251 and 252 of the second embodiment have the advantage that the user can learn the state of the notebook PC in both the opened state and a closed state of the notebook PC. The user can learn the state of the PC by the first indicator 251 during the use of the PC, and learn the state of the PC by the second indicator 252 in carrying the PC.

The first indicator 251 for second LED 244 can be constructed similarly to the first indicator 251 for first LED 243 of FIG. 11. The notebook PC of the second embodiment includes the three first indicators 251 as the first indicator 251 for second LED 244. In the second embodiment, the indicators 251 are brightened by the three second LEDs 244.

(2) Details of First and Second Lenses 253 and 254

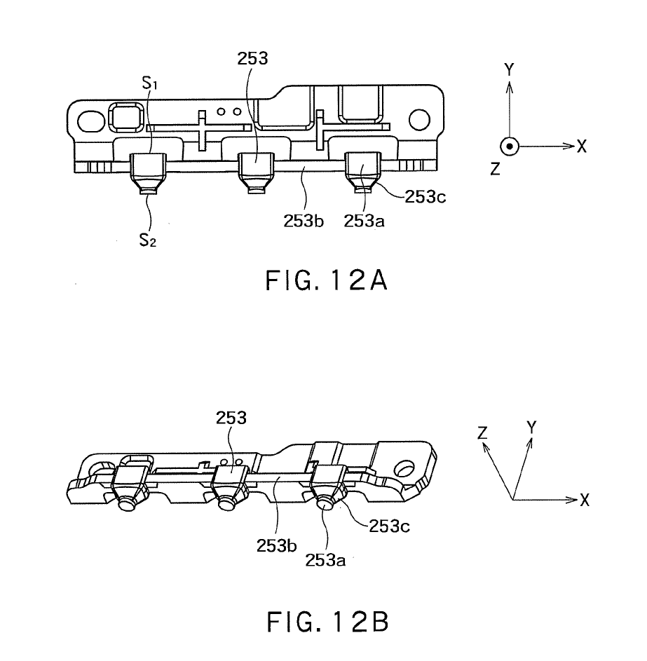

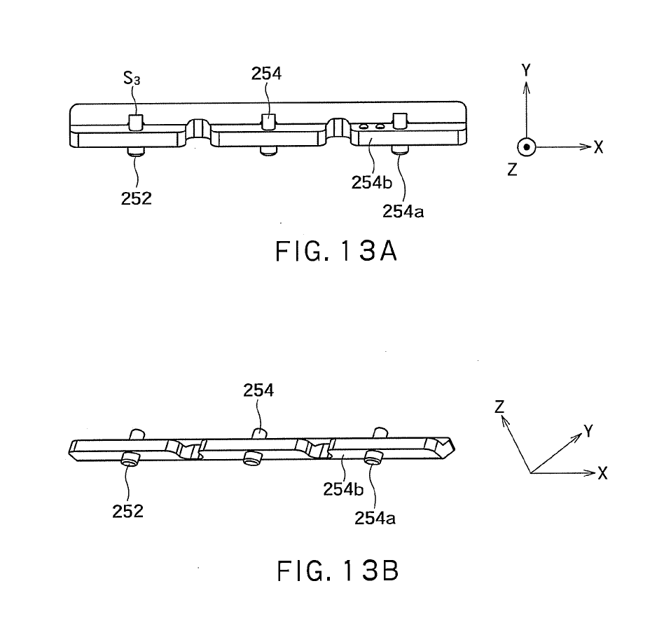

The first and second lenses 253 and 254 will be described in detail with reference to FIGS. 12 and 13.

FIGS. 12A and 12B are front and perspective views illustrating a shape of the first lens, respectively.

As illustrated in FIGS. 12A and 12B, the first lens 253 includes lens bodies 253a as many as the first LEDs 243 and a joining unit 253b that joins the lens bodies 253a. The lens bodies 253a are inserted in the second recesses 245 (FIGS. 10A and 10B) of the circuit board 233 for the click buttons 234.

Each lens body 253a includes a lens narrowed portion 253c that narrows a sectional area on the side of the light emitting surface S₂ such that the sectional area on the side of the light emitting surface S₂ is smaller than a sectional area on the side of the light receiving surface S₁. As can be seen from FIG. 12A, the sectional area in an XZ-section of each lens body 253a is reduced bordering the lens narrowed portion 253c. The configuration of the lens body 253a has an effect to increase the light quantity of the second indicator 252.

FIGS. 13A and 13B are front and perspective views illustrating a shape of the second lens, respectively.

As illustrated in FIGS. 13A and 13B, the second lens 254 includes lens bodies 254a as many as the first LEDs 243 and a joining unit 254b that joins the lens bodies 254a.

Each lens body 254a is protruded to the direction of the second indicator 252 with respect to the joining unit 254b. The protruded portion of each lens body 254a is inserted in an opening provided in the planar portion 227a of the peripheral surface 227. Therefore, the protruded portion can be used as the second indicator 252.

(3) Details of Front Surface 225 of Second Housing 213

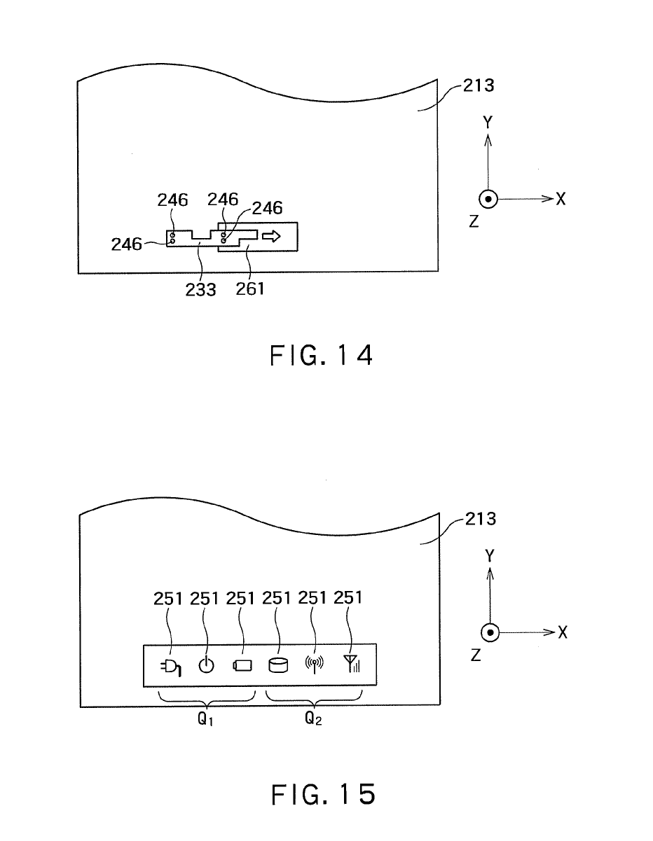

The front surface 225 of the second housing 213 will be described in detail with reference to FIGS. 14 and 15.

FIG. 14 is a front view for explaining a method for attaching the circuit board 233 for the click buttons 234.

As illustrated in FIG. 14, the front surface 225 of the second housing 213 includes an opening 261 in which the circuit board 233 is inserted and attached to the second main body unit 202. As indicated by an arrow of FIG. 14, the circuit board 233 is inserted in the opening 261 while facing toward a positive +X-direction.

For example, the circuit board 233 of the second embodiment includes four screw holes 246. In the four screw holes 246, the two screw holes 246 on the left side are made in the end portion on the left side of the circuit board 233. On the other hand, the two screw holes 246 on the right side are made far away from the end portion on the right side of the circuit board 233. This is because that a leading end on the right side of the circuit board 233 is inserted in the back side of the front surface 225 from the opening 261. The circuit board 233 is fixed to the second main body unit 202 by attaching the screw to the screw hole 246.

FIG. 15 is a front view illustrating a specific example of the first indicator 251.

FIG. 15 illustrates the six first indicators 251 that are provided on the front surface 225 of the second housing 213. The three first indicators 251, which are designated by a symbol Q₁, indicate charging, charged, and power-on/power-off, respectively. The three first indicators 251, which are designated by a symbol Q₂, are an HDD indicator, a wireless LAN indicator, and a radio-wave-condition indicator, respectively.

In these first indicators 251, display contents of the first indicators 251 designated by the symbol Q₁ are pieces of information, which are what the user wants to learn even when the user is carrying the PC. Therefore, in the second embodiment, the three second indicators 252 corresponding to the first indicators 251 designated by the symbol Q₁ are provided on the peripheral surface 227 of the second housing 213 (see FIG. 4D).

(4) Effect of Second Embodiment

Finally, an effect of the second embodiment will finally be described.

As described above, in the second embodiment, the light emitted from the LED 243 is incident to both the first indicator 251 and the second indicator 252 by dividing the optical path of the light emitted from the LED 243 using at least the one lens 253 or 254. In the second embodiment, the first and second indicators 251 and 252 can be brightened by the light emitted from the same LED 243. Therefore, according to the second embodiment, the number of LEDs 243 for indicators 251 and 252 can be decreased.

The second embodiment can also be applied to various electronic devices, except the notebook PC, such as the television receiver.

While certain embodiments have been described, these embodiments have been presented by way of example only, and are not intended to limit the scope of the inventions. Indeed, the novel receivers and devices described herein may be embodied in a variety of other forms; furthermore, various omissions, substitutions and changes in the form of the receivers and devices described herein may be made without departing from the spirit of the inventions. The accompanying claims and their equivalents are intended to cover such forms or modifications as would fall within the scope and spirit of the inventions.

1. A television receiver comprising:
a housing comprising a first surface, a second surface located on an opposite side of the first surface, and a third surface connected to the first surface and the second surface;
a circuit board in the housing, having a first board surface facing the first surface, and a second board surface facing the second surface;
a light source disposed on the first board surface of the circuit board;
at least one lens configured to adjust an optical path of light emitted from the light source;
a first indicator provided on the first surface of the housing and configured to transmit the light emitted from the light source; and
a second indicator provided on the third surface of the housing and configured to transmit the light emitted from the light source and transmitted through the lens.

2. The receiver of claim 1, wherein the at least one lens comprises:
a first lens configured to transmit the light emitted from the light source; and
a second lens configured to transmit the light transmitted through the first lens.

3. The receiver of claim 2, wherein the first lens comprises a narrowed portion to narrow a sectional area on a light emitting surface side to be smaller than a sectional area on a light receiving surface side.

4. The receiver of claim 2, wherein an area of a light receiving surface of the second lens is smaller than an area of a light emitting surface of the first lens.

5. The receiver of claim 2, wherein the circuit board comprises a recess configured to receive the first lens.

6. The receiver of claim 2, wherein a light emitting surface of the second lens is the second indicator.

7. The receiver of claim 1, wherein the light emitted from the light source is incident to the first indicator without passing through the lens.

8. The receiver of claim 1, wherein an input operating button is disposed on the circuit board.

9. The receiver of claim 1, wherein
the third surface comprises a planar portion located on the first surface side, and a curved portion located on the second surface side, and
the second indicator is provided in the planar portion.

10. An electronic device comprising:
a housing;
a light source in the housing;
at least one lens configured to adjust an optical path of light emitted from the light source;
a first indicator provided in the housing and configured to transmit the light emitted from the light source; and
a second indicator provided in the housing and configured to transmit the light emitted from the light source and transmitted through the lens.
